(19) United States
(12) Patent Application Publication
(10) Pub. No.: US 2022/0416861 A1
(43) Pub. Date: Dec. 29, 2022

(54) CHANNEL STATE INFORMATION FEEDBACK COMPRESSION

(71) Applicant: QUALCOMM Incorporated, San Diego, CA (US)

(72) Inventors: Alexandros MANOLAKOS, Escondido, CA (US); Yu ZHANG, San Diego, CA (US); Pavan Kumar VITTHALADEVUNI, San Diego, CA (US); Yeliz TOKGOZ, San Diego, CA (US); Krishna Kiran MUKKAVILLI, San Diego, CA (US)

(21) Appl. No.: 17/755,817

(22) PCT Filed: Nov. 18, 2019
(86) PCT No.: PCT/CN2019/119093

§ 371 Date: May 9, 2022

(51) Int. Cl. H04B 7/06; H04L 1/00

(52) U.S. Cl. CPC H04B 7/065; H04L 1/0027; H04L 1/003; H04B 7/0626; H04B 7/0658

(57) ABSTRACT

Various aspects of the present disclosure generally relate to wireless communication. In some aspects, a user equipment (UE) may transmit a first part of a channel state information (CSI) report, wherein the first part includes an indication of whether a value of a second part of the CSI report matches a value of a previous CSI report; and selectively transmit the second part of the CSI report based at least in part on whether the indication indicates that the value of the second part of the CSI report matches the value of the previous CSI report. In some aspects, a UE may determine a modified subband size of the UE, wherein the modified subband size is different than a configured subband size of the UE; and transmit, in a CSI report, an indication regarding the modified subband size to a base station. Numerous other aspects are provided.

### FIELD OF THE DISCLOSURE

Aspects of the present disclosure generally relate to wireless communication and to techniques and apparatuses for channel state information (CSI) feedback compression.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include transmitting a first part of a channel state information (CSI) report, wherein the first part includes an indication of whether a value of a second part of the CSI report matches a value of a previous CSI report; and selectively transmitting the second part of the CSI report based at least in part on whether the indication indicates that the value of the second part of the CSI report matches the value of the previous CSI report.

In some aspects, a method of wireless communication, performed by a user equipment (UE), may include determining a modified subband size of the UE, wherein the modified subband size is different than a configured subband size of the UE; and transmitting, in a channel state information (CSI) report, an indication regarding the modified subband size to a base station.

In some aspects, a method of wireless communication, performed by a base station, may include receiving a first part of a channel state information (CSI) report from a user equipment (UE), wherein the first part includes an indication of whether a value of a second part of the CSI report matches a value of a previous CSI report; and selectively receiving the second part of the CSI report based at least in part on whether the indication indicates that the value of the second part of the CSI report matches the value of the previous CSI report.

In some aspects, a method of wireless communication, performed by a base station, may include receiving, from a user equipment (UE) and in a channel state information (CSI) report, an indication regarding a modified subband size of the UE, wherein the modified subband size is different than a configured subband size of the UE; and communicating with the UE using the modified subband size.

In some aspects, a UE for wireless communication may include memory and one or more processors operatively coupled to the memory. The memory and the one or more processors may be configured to transmit a first part of a channel state information (CSI) report, wherein the first part includes an indication of whether a value of a second part of the CSI report matches a value of a previous CSI report; and selectively transmit the second part of the CSI report based at least in part on whether the indication indicates that the value of the second part of the CSI report matches the value of the previous CSI report.

In some aspects, a UE for wireless communication may include memory and one or more processors operatively coupled to the memory. The memory and the one or more processors may be configured to determine a modified subband size of the UE, wherein the modified subband size is different than a configured subband size of the UE; and transmit, in a channel state information (CSI) report, an indication regarding the modified subband size to a base station.

In some aspects, a base station for wireless communication may include memory and one or more processors operatively coupled to the memory. The memory and the one or more processors may be configured to receive a first part of a channel state information (CSI) report from a user equipment (UE), wherein the first part includes an indication of whether a value of a second part of the CSI report matches a value of a previous CSI report; and selectively receive the second part of the CSI report based at least in part on whether the indication indicates that the value of the second part of the CSI report matches the value of the previous CSI report.

In some aspects, a base station for wireless communication may include memory and one or more processors operatively coupled to the memory. The memory and the one or more processors may be configured to receive, from a user equipment (UE) and in a channel state information (CSI) report, an indication regarding a modified subband size of the UE, wherein the modified subband size is different than a configured subband size of the UE; and communicate with the UE using the modified subband size.

In some aspects, a non-transitory computer-readable medium may store one or more instructions for wireless communication. The one or more instructions, when executed by one or more processors of a UE, may cause the one or more processors to: transmit a first part of a channel state information (CSI) report, wherein the first part includes an indication of whether a value of a second part of the CSI report matches a value of a previous CSI report; and selectively transmit the second part of the CSI report based at least in part on whether the indication indicates that the value of the second part of the CSI report matches the value of the previous CSI report.

In some aspects, a non-transitory computer-readable medium may store one or more instructions for wireless communication. The one or more instructions, when executed by one or more processors of a UE, may cause the one or more processors to: determine a modified subband size of the UE, wherein the modified subband size is different than a configured subband size of the UE; and transmit, in a channel state information (CSI) report, an indication regarding the modified subband size to a base station.

In some aspects, a non-transitory computer-readable medium may store one or more instructions for wireless communication. The one or more instructions, when executed by one or more processors of a base station, may cause the one or more processors to: receive a first part of a channel state information (CSI) report from a user equipment (UE), wherein the first part includes an indication of whether a value of a second part of the CSI report matches a value of a previous CSI report; and selectively receive the second part of the CSI report based at least in part on whether the indication indicates that the value of the second part of the CSI report matches the value of the previous CSI report.

In some aspects, a non-transitory computer-readable medium may store one or more instructions for wireless communication. The one or more instructions, when executed by one or more processors of a base station, may cause the one or more processors to: receive, from a user equipment (UE) and in a channel state information (CSI) report, an indication regarding a modified subband size of the UE, wherein the modified subband size is different than a configured subband size of the UE; and communicate with the UE using the modified subband size.

In some aspects, an apparatus for wireless communication may include means for transmitting a first part of a channel state information (CSI) report, wherein the first part includes an indication of whether a value of a second part of the CSI report matches a value of a previous CSI report; and means for selectively transmitting the second part of the CSI report based at least in part on whether the indication indicates that the value of the second part of the CSI report matches the value of the previous CSI report.

In some aspects, an apparatus for wireless communication may include means for determining a modified subband size of the apparatus, wherein the modified subband size is different than a configured subband size of the apparatus; and means for transmitting, in a channel state information (CSI) report, an indication regarding the modified subband size to a base station.

In some aspects, an apparatus for wireless communication may include means for receiving a first part of a channel state information (CSI) report from a user equipment (UE), wherein the first part includes an indication of whether a value of a second part of the CSI report matches a value of a previous CSI report; and means for selectively receiving the second part of the CSI report based at least in part on whether the indication indicates that the value of the second part of the CSI report matches the value of the previous CSI report.

In some aspects, an apparatus for wireless communication may include means for receiving, from a user equipment (UE) and in a channel state information (CSI) report, an indication regarding a modified subband size of the UE, wherein the modified subband size is different than a configured subband size of the UE; and means for communicating with the UE using the modified subband size.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example of designs of Type I and Type II CSI codebooks, in accordance with various aspects of the present disclosure.

FIG. 4 is a diagram illustrating an example of design of a Type II CSI codebook, in accordance with various aspects of the present disclosure.

FIG. 5 is a diagram illustrating an example of indication of a previous CSI report for determination of a second part of a CSI report, in accordance with various aspects of the present disclosure.

FIG. 6 is a diagram illustrating an example of indication of a modified subband granularity by a UE, in accordance with various aspects of the present disclosure.

FIG. 7 is a diagram illustrating an example process performed, for example, by a user equipment, in accordance with various aspects of the present disclosure.

FIG. 8 is a diagram illustrating an example process performed, for example, by a user equipment, in accordance with various aspects of the present disclosure.

FIG. 9 is a diagram illustrating an example process performed, for example, by a base station, in accordance with various aspects of the present disclosure.

FIG. 10 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

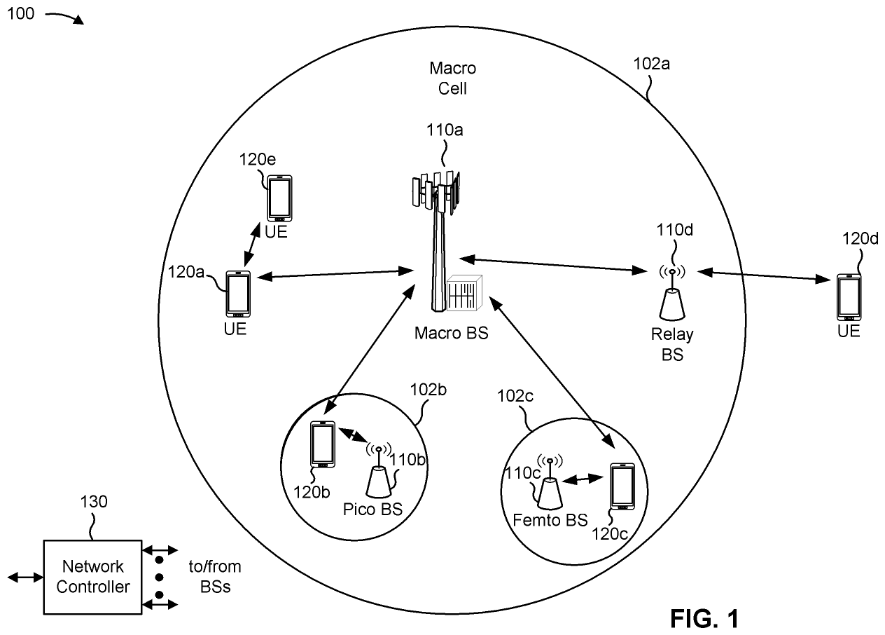

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

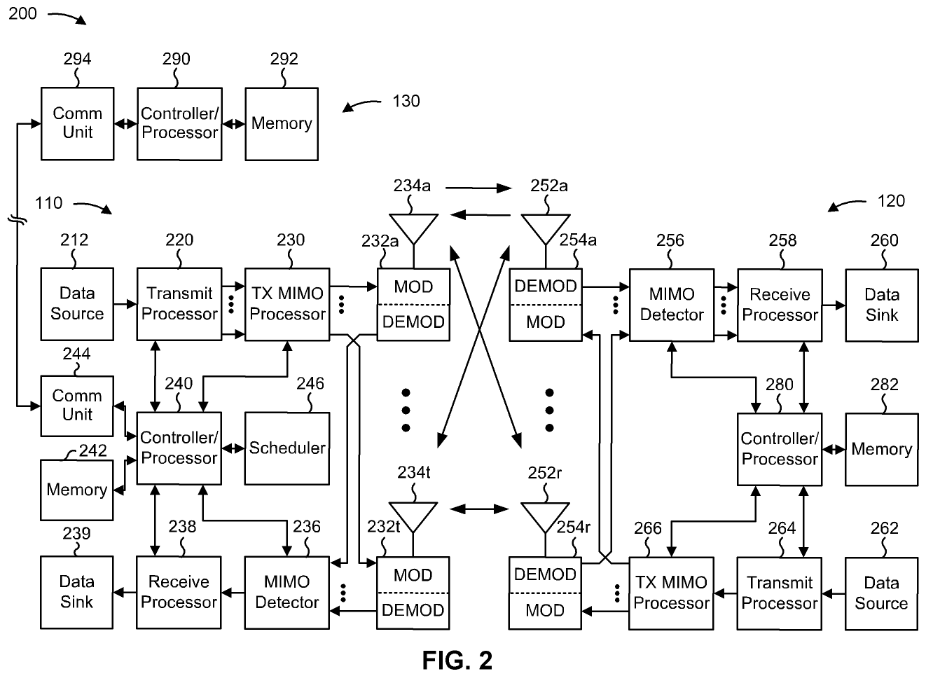

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

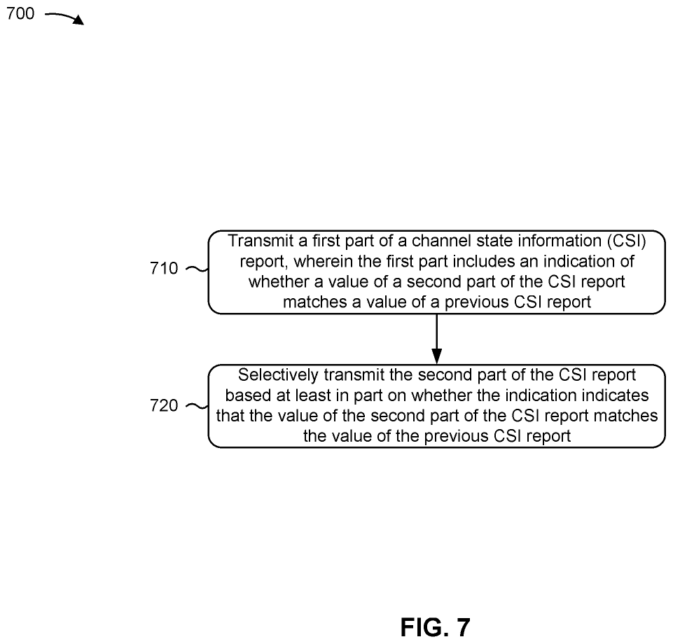

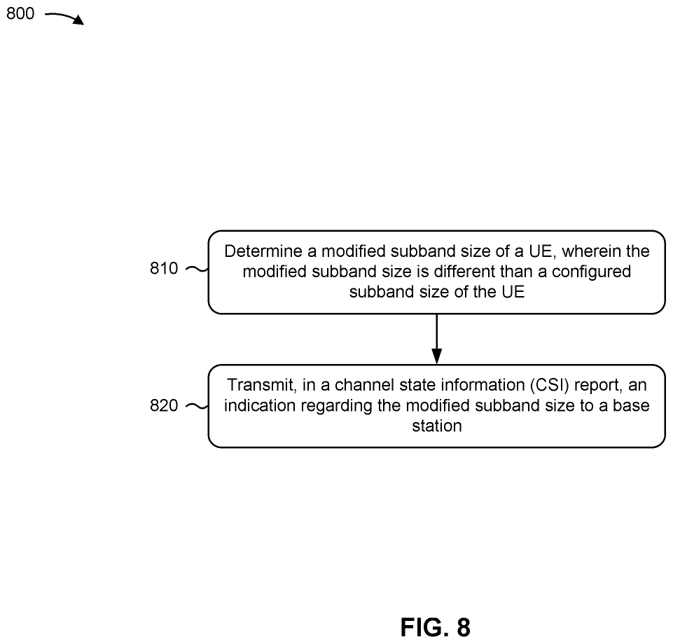

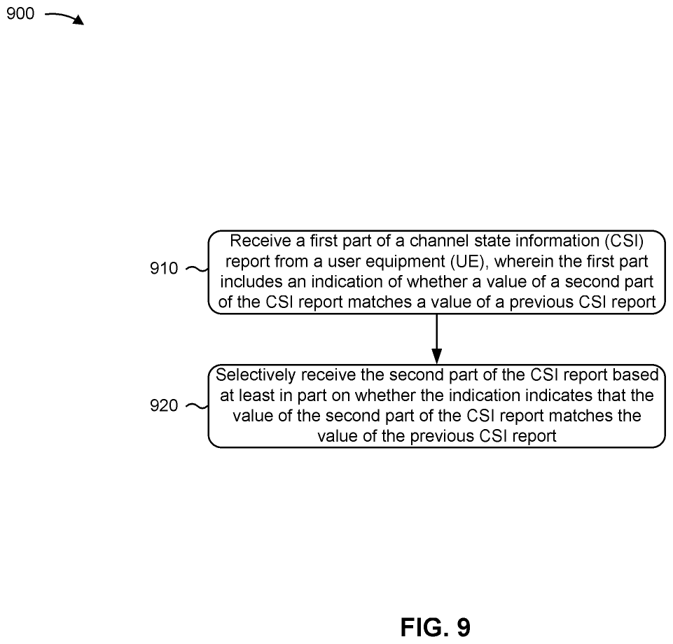

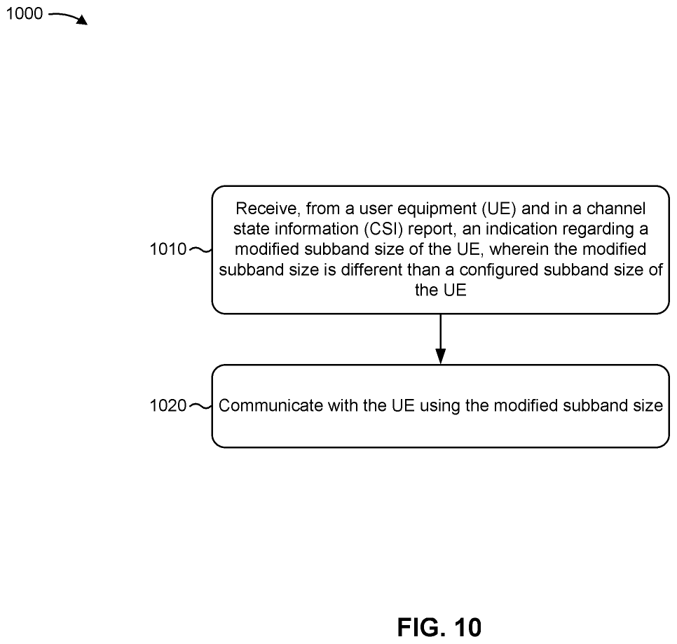

Controller/processor 240 of base station 110, controller/processor 280 of UE 120, and/or any other component(s) of FIG. 2 may perform one or more techniques associated with CSI feedback compression, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 700 of FIG. 7, process 800 of FIG. 8, process 900 of FIG. 9, process 1000 of FIG. 10, and/or other processes as described herein. A scheduler 246 may schedule UEs for data transmission on the downlink and/or uplink.

In some aspects, UE 120 may include means for transmitting a first part of a channel state information (CSI) report, wherein the first part includes an indication of whether a value of a second part of the CSI report matches a value of a previous CSI report; means for selectively transmitting the second part of the CSI report based at least in part on whether the indication indicates that the value of the second part of the CSI report matches the value of the previous CSI report; means for determining a modified subband size of the UE, wherein the modified subband size is different than a configured subband size of the UE; means for transmitting, in a channel state information (CSI) report, an indication regarding the modified subband size to a base station; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for receiving a first part of a channel state information (CSI) report from a user equipment (UE), wherein the first part includes an indication of whether a value of a second part of the CSI report matches a value of a previous CSI report; means for selectively receiving the second part of the CSI report based at least in part on whether the indication indicates that the value of the second part of the CSI report matches the value of the previous CSI report; means for determining the value of the second part of the CSI report based at least in part on the value of the previous CSI report; means for receiving, from a user equipment (UE) and in a channel state information (CSI) report, an indication regarding a modified subband size of the UE, wherein the modified subband size is different than a configured subband size of the UE; means for communicating with the UE using the modified subband size; means for configuring the configured subband size; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

A UE may provide channel state information (CSI) feedback, such as a CSI report, that indicates characteristics of a channel between the UE and a base station. For example, the characteristics may include a channel quality indicator (CQI), a precoding matrix indicator (PMI), a signal to interference and noise ratio (SINR), a reference signal received power (RSRP), a rank indicator (RI), and/or the like. The CSI feedback may be performed at a configurable granularity. For example, a CSI report setting or configuration may define the respective frequency granularity of the PMI and CQI, which can be either wideband or subband. For wideband PMI/CQI, a single PMI/CQI corresponding to the entire CSI reporting band may be reported, whereas for subband PMI/CQI, a separate PMI/CQI may be reported for each constituent subband in the CSI reporting band. The UE may be configured with a subband size. The subband size may indicate one out of a set of possible bandwidth part (BWP)-dependent values for subband size.

The subband CQI may be differentially encoded against a wideband CQI. If the subband CQI is configured, the wideband reference CQI per codeword may also be reported. Similarly, for subband PMI, only part of the PMI (e.g., the W₂ matrix corresponding to the i₂ index, which is described below) may be reported per subband in addition to a single wideband PMI (the i₁ index, which is described below). Which of the subband or wideband CSI reporting granularity is used is a trade-off between CSI accuracy and uplink control information (UCI) overhead. Depending on the UE's uplink coverage, different numbers of bits can reliably be fed back. Thus, a UE with good UL coverage could be configured with subband PMI/CQI reporting, whereas a UE with poor UL coverage could be configured with wideband PMI/CQI, thereby allowing the UE with good UL coverage to provide more granular reporting and the UE with poor UL coverage to provide more robust wideband reporting.

The UE may perform CSI feedback reporting based at least in part on a CSI codebook, referred to hereinafter as a codebook for brevity. A codebook may be a Type I codebook, for which a single preferred beam is selected and information regarding this single preferred beam is fed back, or a Type II codebook, for which information regarding a linear combination of multiple beams is fed back. The design of the codebook is described in more detail elsewhere herein.

The reported parameters of the CSI report(s) are encoded in UCI and mapped to a physical uplink shared channel (PUSCH) or a physical uplink control channel (PUCCH). The encoding format used may depend on the physical channel used and the frequency granularity of the CSI report(s). The reason for the different encoding schemes is that the payload size of the CSI generally varies with the UE's selection of CSI reference signal resource indicator (CRI) and RI. That is, the codebook size for PMI reporting is different for different ranks, especially for Type II CSI codebook reporting and subband PMI reporting in general, where the codebook size can vary drastically.

Similarly, as one codeword is used up to rank-4 and 2 codewords is used for higher ranks, the number of CQI parameters (which is given per codeword) included in the CSI report will vary depending on the selection of rank. For PUCCH-based CSI reporting with wideband frequency granularity, a single packet encoding of all CSI parameters in UCI is used, since the variation of PMI/CQI payload depending on the selected rank is not too large. In this case, since the base station may need to know the payload size of the UCI in order to try to decode the transmission, the UCI may be padded with a number of dummy bits corresponding to the difference between the maximum UCI payload size (e.g., corresponding to the RI which results in the largest PMI/CQI overhead) and the actual payload size of the CSI report. This ensures that the payload size is fixed irrespective of the UE's RI selection. If this measure was not taken, the base station may have to blindly detect the UCI payload size and try to decode for all possible UCI payload sizes, which takes significant time and computing resources.

For PUCCH-based CSI with subband frequency granularity, as well as for PUSCH-based CSI reporting, always padding the CSI report to the worst-case UCI payload size may result in untenable overhead. For these cases, the CSI content is instead divided into two CSI Parts, CSI Part 1 and CSI Part 2, where CSI Part 1 has a fixed payload size (and can be decoded by the base station without prior information) and CSI Part 2 has a variable payload size. The payload size of CSI Part 2 can be derived from the CSI parameters in CSI Part 1. That is, the base station may first decode CSI Part 1 to obtain a subset of the CSI parameters. Using the subset of the CSI parameters, the payload size of CSI Part 2 can be inferred, and CSI Part 2 can be subsequently decoded to obtain the remainder of the CSI parameters.

For PUCCH-based subband CSI reports and PUSCH-based reports with Type I CSI feedback, the CSI Part 1 contains RI (if reported), CRI (if reported), and CQI for the first codeword, while CSI Part 2 contains PMI and CQI for the second codeword when RI>4. For Type II CSI feedback on the PUSCH, CSI Part 2 may also contain an indication of the number of “non-zero wideband amplitude coefficients” per layer. The wideband amplitude coefficient is part of the Type II codebook and depending on if a coefficient is zero or not, the PMI payload size will vary, which is why an indication of the number of non-zero coefficients may be included in CSI Part 1. The CSI Part 1 is sometimes referred to herein as a first part of a CSI report, and the CSI Part 2 is sometimes referred to herein as a second part of the CSI report.

Type II CSI feedback can be resource-intensive and lead to heavy overhead, particularly for cell-edge users that might not be associated with satisfactory coverage. If a UE cannot reliably provide Type II CSI feedback due to the large size and complexity of the payload, then network performance may suffer, leading to wasted computing resources and decreased throughput.

Some techniques and apparatuses described herein provide for compression of a Type II CSI report by signaling, in a first part of the Type II CSI report, whether a value in a second part of the Type II CSI report matches a value of a previous Type II CSI report. For example, if the UE transmits a first CSI report having a particular PMI or CQI value in the second part, then determines that a second CSI report is to be transmitted that also has the particular PMI or CQI value, then the UE may transmit a second CSI report that refers back to the first CSI report's second part. In this case, the UE may not transmit the second part of the second CSI report, thereby saving computing resources and reducing overhead. This reference back to the previous CSI report may be transmitted in the first part of the CSI report, so that a base station that receives the CSI report can determine, from the first part of the CSI report, that no second part of the CSI report is to be received or decoded, thereby conserving computing resources and reducing overhead at the base station.

Furthermore, some techniques and apparatuses described herein provide for a UE to select a subband size that is different than a configured subband size of the UE, and signal the selected subband size to a base station that configured the configured subband size. For example, if the frequency selectivity of the channel is not as high as the subband feedback granularity configured for the UE, then the UE may waste resources reporting CSI feedback at an unnecessarily high granularity. In this case, the UE may request a different subband size, such as a larger subband size, which may reduce reporting overhead and conserve computing resources.

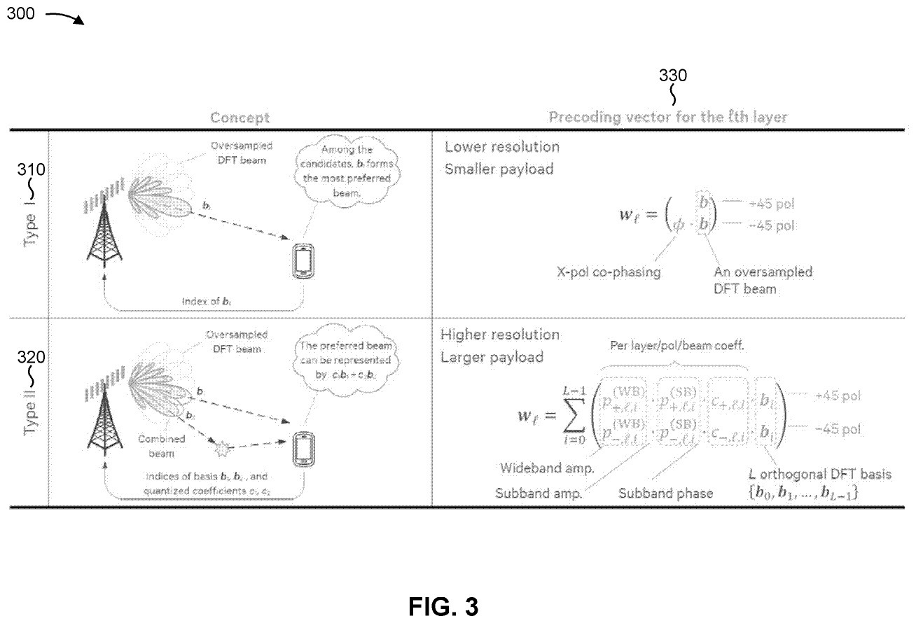

FIG. 3 is a diagram illustrating an example 300 of designs of Type I and Type II CSI codebooks, in accordance with various aspects of the present disclosure. The row shown by reference number 310 shows a Type I CSI codebook design and the row shown by reference number 320 shows a Type II CSI codebook design. As shown by reference number 310, in the Type I CSI codebook design, a UE may select an index b₁ of a preferred beam from an oversampled discrete Fourier transform (DFT) beam, and may feed back an index of b₁ to the base station that transmitted the oversampled DFT beam. As further shown, the Type I CSI codebook may involve lower resolution and a smaller payload than the Type II CSI codebook design based at least in part on the feedback indicating a single selected beam, and based at least in part on the precoding vector for the lth layer being simpler than the precoding vector for the Type II CSI codebook.

As shown by reference number 330, in the Type II CSI codebook design, a UE may select a combined beam formed from multiple beams (here, b₁ and b₂). The UE may feed back information identifying the combined beam, such as a linear combination that defines the combined beam as a function of b₁ and b₂. Furthermore, as shown, the precoding vector for the Type II CSI codebook may identify wideband amplitudes and/or subband amplitudes per layer, polarization, and/or beam coefficient. Thus, the precoding vector for the Type II CSI codebook may be associated with higher resolution and a larger payload than the precoding vector for the Type I CSI codebook.

As indicated above, FIG. 3 is provided as an example. Other examples may differ from what is described with respect to FIG. 3.

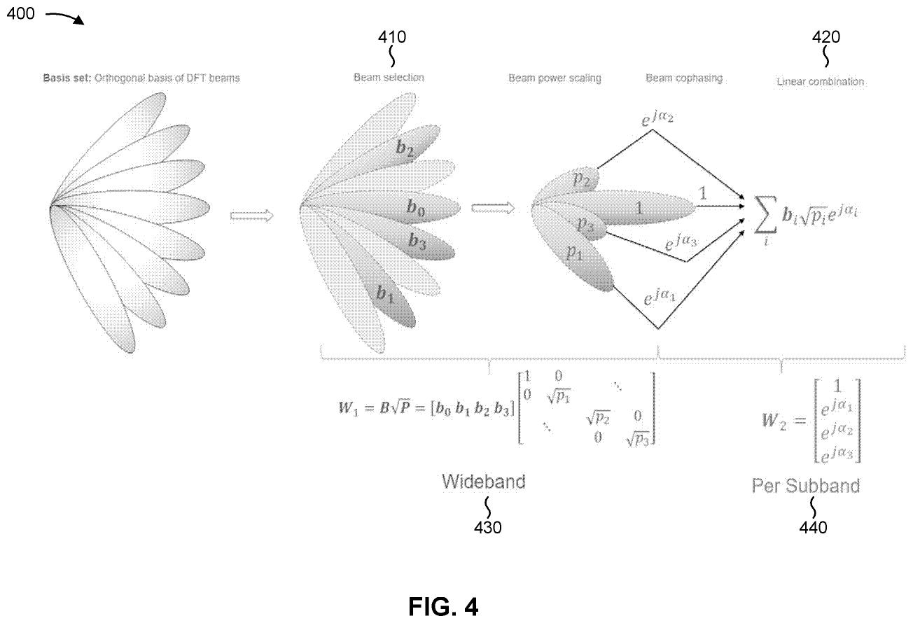

FIG. 4 is a diagram illustrating an example 400 of design of a Type II CSI codebook, in accordance with various aspects of the present disclosure.

The NR Type II Codebook design includes two components, spatial basis selection (shown by reference number 410) and basis linear combination (shown by reference number 420). The spatial basis may be constructed from columns of a dual-polarized 2D-DFT matrix (assuming a uniform planar array (UPA) structure of antenna ports) in order to correspond to different beam 2D directions. The precoder vector for a layer may be formed by linearly combining the basis vectors (e.g., weighting the basis vectors together using different amplitude and phase weights). The precoding vectors may use a dual-stage W=W₁W₂ structure as the Type I codebooks, where W₁ (shown by reference number 430) is the selected wideband while W₂ (shown by reference number 440) is selected per subband. The basis/beam selection may be performed in W₁ while selection of beam phase weights is performed frequency-selectively in W₂. Wideband beam amplitude weights are also included in W₁ and in addition, differential subband amplitude weights can be included in W₂.

As indicated above, FIG. 4 is provided as an example. Other examples may differ from what is described with respect to FIG. 4.

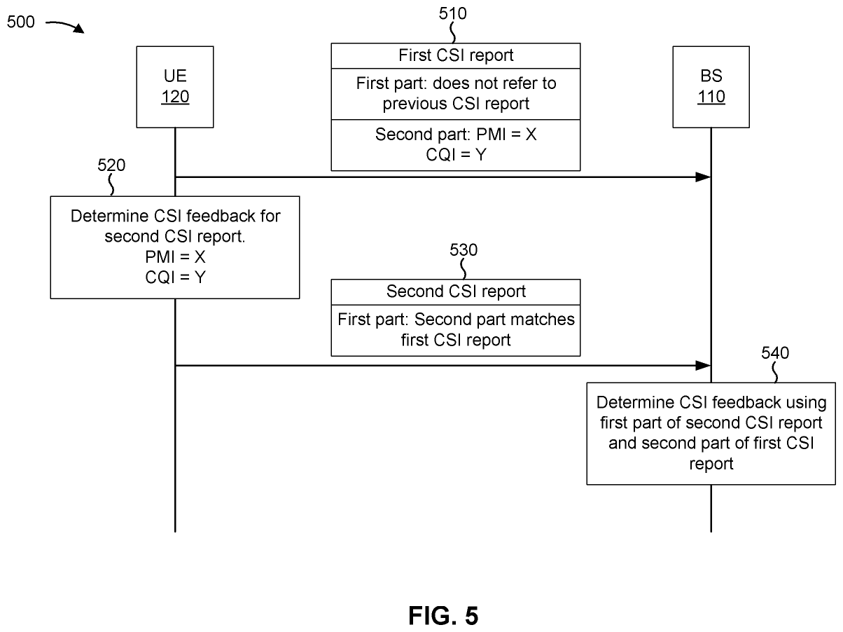

FIG. 5 is a diagram illustrating an example 500 of indication of a previous CSI report for determination of a second part of a CSI report, in accordance with various aspects of the present disclosure. As shown, example 500 includes a UE 120 and a BS 110.

As shown in FIG. 5, and by reference number 510, the UE 120 may transmit a first CSI report that includes a first part (e.g., a CSI Part 1) and a second part (e.g., a CSI Part 2). For example, the first CSI report may be a CSI Type II report. As shown, the first part does not refer back to a previous CSI report to indicate the second part of the CSI report. Accordingly, the UE 120 transmits the second part of the CSI report indicating a PMI of X and CQI of Y. In some aspects, the second part of the CSI report may include additional and/or different values, such as an SINR, a reference signal received power (RSRP), a reference signal received quality (RSRQ), an RI, and/or other values.

As shown by reference number 520, the UE 120 may determine CSI feedback to be transmitted in a second CSI report. As further shown, the UE 120 may determine a PMI of X and a CQI of Y, which match the PMI and CQI values of the second part of the first CSI report. As shown by reference number 530, the UE 120 may transmit an indication, in the first part of the second CSI report, that a second part of the second CSI report matches the second part of the first CSI report. Thus, the UE 120 may not transmit the second part of the second CSI report, thereby conserving computing resources and network resources. As shown by reference number 540, the BS 110 may receive the first part of the second CSI report, and may determine the CSI feedback using the first part of the second report and the second part of the first report, thereby conserving computing resources that would otherwise be used to detect and decode the second part of the second CSI report.

In some aspects, the UE 120 may provide a per-subband indication of whether the second part of the CSI report matches a previous CSI report. For example, the first part of the CSI report may indicate that the second part of the CSI report matches a previous CSI report for a first subband and not for a second subband, which provides additional flexibility relative to an all-or-nothing approach in which the CSI feedback for all subbands must match the previous CSI report. Conversely, the all-or-nothing approach may reduce signaling overhead relative to a per-subband indication. In some aspects, the UE 120 may provide a per-value indication of whether the second part of the CSI report matches the previous CSI report. For example, the first part of the CSI report may indicate that a PMI value matches a previous CSI report and that a CQI value does not match the previous CSI report, or that the PMI value and the CQI value match different previous CSI reports.

In some aspects, the UE 120 may indicate the previous CSI report using a time index associated with the previous CSI report. In some aspects, the UE 120 may indicate the previous CSI report using a CSI report identifier of the previous CSI report.

In some aspects, the UE 120 may be configured to report whether the second part matches a previous CSI report. For example, a CSI report setting or configuration of the UE 120 may indicate whether the UE 120 is to report whether the second part matches the previous CSI report.

In some aspects, the UE 120 may be configured to report whether the second part matches the previous CSI report for a particular type of CSI report. For example, the UE 120 may be configured to perform this reporting only for an aperiodic CSI report, only for a periodic CSI report, only for a semi-persistent CSI report, or for a combination of these types of CSI report.

In some aspects, the UE 120 may be configured to select a previous CSI report within a time window. For example, the UE 120 may select a previous CSI report that occurs at least a threshold time earlier than the CSI report. Additionally, or alternatively, the UE 120 may select a previous CSI report that occurs at most a threshold time earlier than the CSI report. As another example, the UE 120 may select a previous CSI report that occurs within a same discontinuous reception (DRX) ON duration as the CSI report. This may conserve resources of the UE 120 and the BS 110 that would otherwise be used to store a larger number of previous CSI reports outside of the time window.

In some aspects, the UE 120 may select a previous CSI report that is associated with a same CSI report identifier as the CSI report. For example, the UE 120 may select an earlier triggered, configured, or activated instance of the same CSI report identifier. In some aspects, the CSI report and/or the previous CSI report may be a subband granularity CSI report and a Type II CSI report.

In some aspects, the UE 120 may selectively indicate the previous CSI report based at least in part on a code rate or payload size of UCI used to transmit the CSI report. For example, the UE 120 may indicate the previous CSI report if the resulting code rate of the UCI satisfies a threshold. As another example, the UE 120 may indicate the previous CSI report if the payload of the UCI satisfies a threshold (e.g., is more than Y bits).

In some aspects, the UE 120 may be configured with a threshold for a number of consecutive indications of a previous CSI report. For example, the UE 120 may be configured to provide a CSI report that identifies a previous CSI report no more than X times, where X is a positive integer. This may conserve resources of the UE 120 and the BS 110 that would otherwise be used to store a larger number of previous CSI reports because the UE 120 repeatedly refers back to a stored CSI report over a large length of time.

As indicated above, FIG. 5 is provided as an example. Other examples may differ from what is described with regard to FIG. 5.

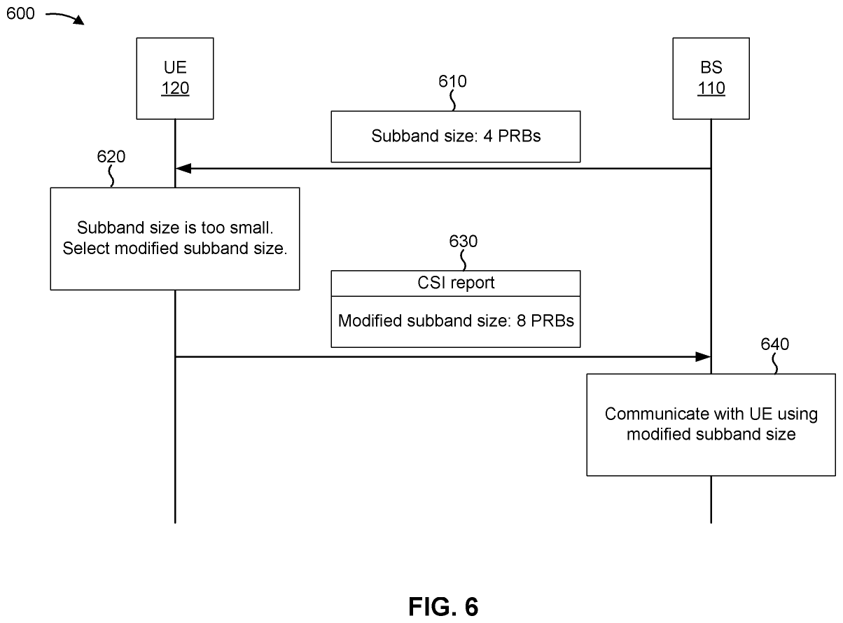

FIG. 6 is a diagram illustrating an example 600 of indication of a modified subband granularity by a UE, in accordance with various aspects of the present disclosure. As shown, example 600 includes a UE 120 and a BS 110.

As shown in FIG. 6, and by reference number 610, the BS 110 may configure the UE 120 with a subband size (referred to hereinafter as a configured subband size). Here, the configured subband size is 4 physical resource blocks (PRBs). The UE 120 may perform CSI reporting at a granularity matching the configured subband size. Therefore, a smaller configured subband size may cause more overhead and computing resource usage for the UE 120 than a larger configured subband size.

As shown by reference number 620, the UE 120 may select a modified subband size. For example, the UE 120 may select the modified subband size to reduce the overhead and computing resource usage associated with determining CSI feedback. In some aspects, the UE 120 may determine that a frequency selectivity of the channel is less granular than the configured subband size, meaning that a larger subband size can be used without losing significant information about the channel state. In this case, the UE 120 may select a larger subband size or may select a wideband reporting configuration.

As shown by reference number 630, the UE 120 may transmit a CSI report that identifies the modified subband size. For example, an indication of the modified subband size may be carried in a first part of the CSI report. In some aspects, the UE 120 may provide the indication of the subband size (or whether the UE 120 is to perform wideband reporting) autonomously (e.g., without receiving a request or instruction from the BS 110 to do so). In some aspects, the UE 120 may select only a larger subband size. For example, selecting a smaller subband size may lead to higher overhead and increased PUSCH or PUCCH resource usage. In some aspects, the UE 120 may be permitted to select any supportable subband size independent of a BWP size of the UE 120 (e.g., 4 PRBs, 8 PRBs, 16 PRBs, 32 PRBs, wideband). In some aspects, the UE 120 may select a subband size based at least in part on a BWP size of the UE 120.

As shown by reference number 640, the BS 110 may communicate with the UE 120 based at least in part on the modified subband size. For example, the UE 120 may transmit, and the BS 110 may receive, CSI reports based at least in part on the modified subband size. The BS 110 may configure communications to and/or from the UE 120 in accordance with the CSI feedback using the modified subband size. In this way, overhead may be reduced and computing resources of the UE 120 and the BS 110 may be conserved.

As indicated above FIG. 6 is provided as an example. Other examples may differ from what is described with regard to FIG. 6.

FIG. 7 is a diagram illustrating an example process 700 performed, for example, by a UE, in accordance with various aspects of the present disclosure. Example process 700 is an example where the UE (e.g., UE 120 and/or the like) performs operations associated with channel state information feedback compression.

As shown in FIG. 7, in some aspects, process 700 may include transmitting a first part of a channel state information (CSI) report, wherein the first part includes an indication of whether a value of a second part of the CSI report matches a value of a previous CSI report (block 710). For example, the UE (e.g., using controller/processor 280, transmit processor 264, TX MIMO processor 266, MOD 254, antenna 252, and/or the like) may transmit a first part of a channel state information (CSI) report, as described above. In some aspects, the first part includes an indication of whether a value of a second part of the CSI report matches a value of a previous CSI report.

As further shown in FIG. 7, in some aspects, process 700 may include selectively transmitting the second part of the CSI report based at least in part on whether the indication indicates that the value of the second part of the CSI report matches the value of the previous CSI report (block 720). For example, the UE (e.g., using controller/processor 280, transmit processor 264, TX MIMO processor 266, MOD 254, antenna 252, and/or the like) may selectively transmit the second part of the CSI report based at least in part on whether the indication indicates that the value of the second part of the CSI report matches the value of the previous CSI report, as described above.

Process 700 may include additional aspects, such as any single aspect or any combination of aspects described below and/or in connection with one or more other processes described elsewhere herein.

In a first aspect, the second part of the CSI report is not transmitted when the indication indicates that the value of the second part of the CSI report matches the value of the previous CSI report.

In a second aspect, alone or in combination with the first aspect, the value of the second part of the CSI report includes at least one of: a precoding matrix indicator, a channel quality indicator, a rank indicator, a reference signal received power, or a signal to interference and noise ratio.

In a third aspect, alone or in combination with one or more of the first and second aspects, the indication is specific to a sub-band.

In a fourth aspect, alone or in combination with one or more of the first through third aspects, the second part of the CSI report has a variable size.

In a fifth aspect, alone or in combination with one or more of the first through fourth aspects, the indication of whether the value of the second part of the CSI report matches the value of the previous CSI report is included in the first part of the CSI report based at least in part on a configuration of the UE.

In a sixth aspect, alone or in combination with one or more of the first through fifth aspects, the indication includes information identifying the previous CSI report.

In a seventh aspect, alone or in combination with one or more of the first through sixth aspects, the information identifying the previous CSI report includes a time index or a CSI report identifier associated with the previous CSI report.

In an eighth aspect, alone or in combination with one or more of the first through seventh aspects, the indication is provided for one or more of: periodic CSI reports, aperiodic CSI reports, or semi-persistent CSI reports.

In a ninth aspect, alone or in combination with one or more of the first through eighth aspects, the previous CSI report occurs at least a threshold length of time earlier than the CSI report.

In a tenth aspect, alone or in combination with one or more of the first through ninth aspects, the previous CSI report occurs at most a threshold length of time earlier than the CSI report.

In an eleventh aspect, alone or in combination with one or more of the first through tenth aspects, the previous CSI report is associated with a same CSI report identifier as the CSI report.

In a twelfth aspect, alone or in combination with one or more of the first through eleventh aspects, the previous CSI report is associated with a same discontinuous reception ON duration as the CSI report.

In a thirteenth aspect, alone or in combination with one or more of the first through twelfth aspects, the CSI report is a sub-band report.

In a fourteenth aspect, alone or in combination with one or more of the first through thirteenth aspects, the CSI report is a Type II codebook report.

In a fifteenth aspect, alone or in combination with one or more of the first through fourteenth aspects, the first part includes the indication based at least in part on a determination that a code rate of uplink control information carrying the CSI report satisfies a threshold.

In a sixteenth aspect, alone or in combination with one or more of the first through fifteenth aspects, the first part includes the indication based at least in part on a determination that a payload size associated with the CSI report satisfies a threshold.

In a seventeenth aspect, alone or in combination with one or more of the first through sixteenth aspects, the first part includes the indication based at least in part on a determination that a number of consecutive CSI reports including the indication has not reached a threshold.

In an eighteenth aspect, alone or in combination with one or more of the first through seventeenth aspects, the previous CSI report includes a plurality of values, and wherein the indication indicates which value, of the plurality of values, matches the second part of the CSI report.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with various aspects of the present disclosure. Example process 800 is an example where the UE (e.g., UE 120 and/or the like) performs operations associated with subband size selection.

As shown in FIG. 8, in some aspects, process 800 may include determining a modified subband size of the UE, wherein the modified subband size is different than a configured subband size of the UE (block 810). For example, the UE (e.g., using antenna 252, DEMOD 254, MIMO detector 256, receive processor 258, controller/processor 280, and/or the like) may determine a modified subband size of the UE, as described above. In some aspects, the modified subband size is different than a configured subband size of the UE.

As further shown in FIG. 8, in some aspects, process 800 may include transmitting, in a channel state information (CSI) report, an indication regarding the modified subband size to a base station (block 820). For example, the UE (e.g., using controller/processor 280, transmit processor 264, TX MIMO processor 266, MOD 254, antenna 252, and/or the like) may transmit, in a channel state information (CSI) report, an indication regarding the modified subband size to a base station, as described above.

Process 800 may include additional aspects, such as any single aspect or any combination of aspects described below and/or in connection with one or more other processes described elsewhere herein.

In a first aspect, the base station configured the configured subband size.

In a second aspect, alone or in combination with the first aspect, the modified subband size is not permitted to be smaller than the configured subband size.

In a third aspect, alone or in combination with one or more of the first and second aspects, the modified subband size is independent of a bandwidth part size of the UE.

In a fourth aspect, alone or in combination with one or more of the first through third aspects, the modified subband size is based at least in part on a bandwidth part size of the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a BS, in accordance with various aspects of the present disclosure. Example process 900 is an example where the BS (e.g., BS 110 and/or the like) performs operations associated with channel state information feedback compression.

As shown in FIG. 9, in some aspects, process 900 may include receiving a first part of a channel state information (CSI) report from a user equipment (UE), wherein the first part includes an indication of whether a value of a second part of the CSI report matches a value of a previous CSI report (block 910). For example, the BS (e.g., using antenna 234, DEMOD 232, MIMO detector 236, receive processor 238, controller/processor 240, and/or the like) may receive a first part of a channel state information (CSI) report from a user equipment (UE), as described above. In some aspects, the first part includes an indication of whether a value of a second part of the CSI report matches a value of a previous CSI report.

As shown in FIG. 9, in some aspects, process 900 may include selectively receiving the second part of the CSI report based at least in part on whether the indication indicates that the value of the second part of the CSI report matches the value of the previous CSI report (block 920). For example, the BS (e.g., using antenna 234, DEMOD 232, MIMO detector 236, receive processor 238, controller/processor 240, and/or the like) may selectively receive the second part of the CSI report based at least in part on whether the indication indicates that the value of the second part of the CSI report matches the value of the previous CSI report, as described above.

Process 900 may include additional aspects, such as any single aspect or any combination of aspects described below and/or in connection with one or more other processes described elsewhere herein.

In a first aspect, the second part of the CSI report is not received when the indication indicates that the value of the second part of the CSI report matches the value of the previous CSI report.

In a second aspect, alone or in combination with the first aspect, the value of the second part of the CSI report includes at least one of a precoding matrix indicator, a channel quality indicator, a rank indicator, a reference signal received power, or a signal to interference and noise ratio.

In a third aspect, alone or in combination with one or more of the first and second aspects, the indication is specific to a sub-band.

In a fourth aspect, alone or in combination with one or more of the first through third aspects, the second part of the CSI report has a variable size.

In a fifth aspect, alone or in combination with one or more of the first through fourth aspects, the indication of whether the value of the second part of the CSI report matches the value of the previous CSI report is included in the first part of the CSI report based at least in part on a configuration of the UE.

In a sixth aspect, alone or in combination with one or more of the first through fifth aspects, the indication includes information identifying the previous CSI report.

In a seventh aspect, alone or in combination with one or more of the first through sixth aspects, the information identifying the previous CSI report includes a time index or a CSI report identifier associated with the previous CSI report.

In an eighth aspect, alone or in combination with one or more of the first through seventh aspects, the indication is received for one or more of: periodic CSI reports, aperiodic CSI reports, or semi-persistent CSI reports.

In a ninth aspect, alone or in combination with one or more of the first through eighth aspects, the previous CSI report occurs at least a threshold length of time earlier than the CSI report.

In a tenth aspect, alone or in combination with one or more of the first through ninth aspects, the previous CSI report occurs at most a threshold length of time earlier than the CSI report.

In an eleventh aspect, alone or in combination with one or more of the first through tenth aspects, the previous CSI report is associated with a same CSI report identifier as the CSI report.

In a twelfth aspect, alone or in combination with one or more of the first through eleventh aspects, the previous CSI report is associated with a same discontinuous reception ON duration as the CSI report.

In a thirteenth aspect, alone or in combination with one or more of the first through twelfth aspects, the CSI report is a sub-band report.

In a fourteenth aspect, alone or in combination with one or more of the first through thirteenth aspects, the CSI report is a Type II codebook report.

In a fifteenth aspect, alone or in combination with one or more of the first through fourteenth aspects, process 900 includes determining the value of the second part of the CSI report based at least in part on the value of the previous CSI report.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a BS, in accordance with various aspects of the present disclosure. Example process 1000 is an example where the BS (e.g., BS 110 and/or the like) performs operations associated with modified subband size selection.

As shown in FIG. 10, in some aspects, process 1000 may include receiving, from a user equipment (UE) and in a channel state information (CSI) report, an indication regarding a modified subband size of the UE, wherein the modified subband size is different than a configured subband size of the UE (block 1010). For example, the BS (e.g., using antenna 234, DEMOD 232, MIMO detector 236, receive processor 238, controller/processor 240, and/or the like) may receive, from a user equipment (UE) and in a channel state information (CSI) report, an indication regarding a modified subband size of the UE, as described above. In some aspects, the modified subband size is different than a configured subband size of the UE.

As further shown in FIG. 10, in some aspects, process 1000 may include communicating with the UE using the modified subband size (block 1020). For example, the BS (e.g., using controller/processor 240, transmit processor 220, TX MIMO processor 230, MOD 232, antenna 234, and/or the like) may communicate with the UE using the modified subband size, as described above.

Process 1000 may include additional aspects, such as any single aspect or any combination of aspects described below and/or in connection with one or more other processes described elsewhere herein.

In a first aspect, process 1000 includes configuring the configured subband size.

In a second aspect, alone or in combination with the first aspect, the modified subband size is not permitted to be smaller than the configured subband size.

In a third aspect, alone or in combination with one or more of the first and second aspects, the modified subband size is independent of a bandwidth part size of the UE.

In a fourth aspect, alone or in combination with one or more of the first through third aspects, the modified subband size is based at least in part on a bandwidth part size of the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
transmitting a first part of a channel state information (CSI) report, wherein the first part includes an indication of whether a value of a second part of the CSI report matches a value of a previous CSI report; and
selectively transmitting the second part of the CSI report based at least in part on whether the indication indicates that the value of the second part of the CSI report matches the value of the previous CSI report.

2. The method of claim 1, wherein the second part of the CSI report is not transmitted when the indication indicates that the value of the second part of the CSI report matches the value of the previous CSI report.

3. The method of claim 1, wherein the value of the second part of the CSI report includes at least one of:
a precoding matrix indicator,
a channel quality indicator,
a rank indicator,
a reference signal received power, or
a signal to interference and noise ratio.

4. The method of claim 1, wherein the indication is specific to a sub-band.

5. The method of claim 1, wherein the second part of the CSI report has a variable size.

6. The method of claim 1, wherein the indication of whether the value of the second part of the CSI report matches the value of the previous CSI report is included in the first part of the CSI report based at least in part on a configuration of the UE.

7. The method of claim 1, wherein the indication includes information identifying the previous CSI report.

8. The method of claim 7, wherein the information identifying the previous CSI report includes a time index or a CSI report identifier associated with the previous CSI report.

9. The method of claim 1, wherein the indication is provided for one or more of:
periodic CSI reports,
aperiodic CSI reports, or
semi-persistent CSI reports.

10-12. (canceled)

13. The method of claim 1, wherein the previous CSI report is associated with a same discontinuous reception ON duration as the CSI report.

14. The method of claim 1, wherein the CSI report is a sub-band report.

15. The method of claim 1, wherein the CSI report is a Type II codebook report.

16. The method of claim 1, wherein the first part includes the indication based at least in part on a determination that a code rate of uplink control information carrying the CSI report satisfies a threshold.

17. The method of claim 1, wherein the first part includes the indication based at least in part on a determination that a payload size associated with the CSI report satisfies a threshold.

18. The method of claim 1, wherein the first part includes the indication based at least in part on a determination that a number of consecutive CSI reports including the indication has not reached a threshold.

19. The method of claim 1, wherein the previous CSI report includes a plurality of values, and wherein the indication indicates which value, of the plurality of values, matches the second part of the CSI report.

20. A method of wireless communication performed by a user equipment (UE), comprising:
determining a modified subband size of the UE, wherein the modified subband size is different than a configured subband size of the UE; and
transmitting, in a channel state information (CSI) report, an indication regarding the modified subband size to a base station.

21-22. (canceled)

23. The method of claim 20, wherein the modified subband size is independent of a bandwidth part size of the UE.

24. The method of claim 20, wherein the modified subband size is based at least in part on a bandwidth part size of the UE.

25. A method of wireless communication performed by a base station, comprising:
receiving a first part of a channel state information (CSI) report from a user equipment (UE), wherein the first part includes an indication of whether a value of a second part of the CSI report matches a value of a previous CSI report; and
selectively receiving the second part of the CSI report based at least in part on whether the indication indicates that the value of the second part of the CSI report matches the value of the previous CSI report.

26-27. (canceled)

28. The method of claim 25, wherein the indication is specific to a sub-band.

29. The method of claim 25, wherein the second part of the CSI report has a variable size.

30. The method of claim 25, wherein the indication of whether the value of the second part of the CSI report matches the value of the previous CSI report is included in the first part of the CSI report based at least in part on a configuration of the UE.

31. The method of claim 25, wherein the indication includes information identifying the previous CSI report.

32-36. (canceled)

37. The method of claim 25, wherein the previous CSI report is associated with a same discontinuous reception ON duration as the CSI report.

38. The method of claim 25, wherein the CSI report is a sub-band report.

39. The method of claim 25, wherein the CSI report is a Type II codebook report.

40. The method of claim 25, further comprising:
determining the value of the second part of the CSI report based at least in part on the value of the previous CSI report.

41. A method of wireless communication performed by a base station, comprising:
receiving, from a user equipment (UE) and in a channel state information (CSI) report, an indication regarding a modified subband size of the UE, wherein the modified subband size is different than a configured subband size of the UE; and
communicating with the UE using the modified subband size.

42. The method of claim 41, further comprising:
configuring the configured subband size.

43. (canceled)

44. The method of claim 41, wherein the modified subband size is independent of a bandwidth part size of the UE.

45. The method of claim 41, wherein the modified subband size is based at least in part on a bandwidth part size of the UE.

46. A user equipment (UE) for wireless communication, comprising:
a memory; and
one or more processors coupled to the memory and configured to:
transmit a first part of a channel state information (CSI) report, wherein the first part includes an indication of whether a value of a second part of the CSI report matches a value of a previous CSI report; and
selectively transmit the second part of the CSI report based at least in part on whether the indication indicates that the value of the second part of the CSI report matches the value of the previous CSI report.

47-57. (canceled)

58. The UE of claim 46, wherein the second part of the CSI report is not transmitted when the indication indicates that the value of the second part of the CSI report matches the value of the previous CSI report.

59. The UE of claim 46, wherein the indication includes information identifying the previous CSI report.
